(19) United States
(12) Patent Application Publication
(10) Pub. No.: US 2007/0200378 A1
(43) Pub. Date: Aug. 30, 2007

(54) Vacuum plate cheese hoist

(76) Inventor: Charles H. Johnson, Westfield, WI (US)

Correspondence Address: BOYLE FREDRICKSON NEWHOLM STEIN & GRATZ, S.C., 250 E. WISCONSIN AVENUE, SUITE 1030, MILWAUKEE, WI, 53202, US

(21) Appl. No.: 11/362,324

(22) Filed: Feb. 24, 2006

(51) Int. Cl. B66C 1/02

(52) U.S. Cl. 294/65

(57) ABSTRACT

A vacuum hoist plate for moving slabs of cheese provides multiple plates positioned at the edges of the slab to bend those slab edges upward reducing suction between the slabs and preventing spalling as the cheese is lifted from a stack.

### CROSS-REFERENCE TO RELATED APPLICATIONS

### STATEMENT REGARDING FEDERALLY SPONSORED RESEARCH OR DEVELOPMENT

### BACKGROUND OF THE INVENTION

The present invention relates to cheese processing equipment, and in particular, to a vacuum hoist for lifting and transporting slabs of cheese.

Referring to FIG. 1, in the manufacture of natural cheese, the cheese curd may be compressed into rectangular blocks of approximately 640 pounds and, for example, 28 inches high and with a horizontal base of 22 by 28 inches. At later steps in the manufacturing process, these blocks may be cut, in-place, to produce a stack 10 of horizontal slabs 12 approximately five to seven inches thick.

The slabs 12 may be separated using a vacuum plate 14 which provides a manifold connecting a vacuum line 16 to a set of regularly spaced holes on the underside of the plate 14. A vacuum may be drawn between the plate 14 and the uppermost slab 12 through the vacuum line 16. Once a vacuum is drawn, the plate may be lifted by means of hoist tabs 24 and the uppermost slab 12 separated from the remainder of the stack 10. The vacuum line 16 may be connected to a venturi-type vacuum pump 18, the latter receiving a compressed air line 20 controlled by an electrically actuated valve 50 (shown in FIG. 5), the latter receiving an electrical actuation signal 22 to switch on and off the compressed air through the compressed air line 20 and hence to switch on and off the vacuum through the vacuum line 16.

The slabs 12 of cheese of the stack 10 often stick together. This sticking can cause a spalling or tearing of the slabs 12 or can break the vacuum between the hoist plate 14 and the slab 12. The operator of the hoist closely must monitor the slab pickup operation closely and may need to use a manual tool to pry up a corner of the uppermost slab 12 so as to break the suction between slabs.

### BRIEF SUMMARY OF THE INVENTION

The present invention provides a vacuum hoist for cheese manufacture that allows the separation of cheese slabs with reduced damage and/or spalling. The broad area of the vacuum plate is divided into one or more articulated sections that may be moved independently to peel the uppermost slab away from the remaining slabs of the stack. The invention thus reduces the need for close operator supervision of the pickup operation and damage to the cheese slab.

Specifically, the present invention provides a cheese hoist having at least two vacuum plates having lower surfaces constructed to retain a vacuum between the lower surfaces and an upper surface of a cheese slab over an area sufficient to support the cheese slab. At least one vacuum plate is positioned adjacent to an edge of the cheese slab and an articulated connector between the vacuum plates allows one vacuum plate to move independently with respect to the other vacuum plate to peel a supported cheese slab away from a surface on which the supported cheese slab rests.

Thus it is one object of at least one embodiment of the invention to apply a peeling action through the vacuum plate itself eliminating damage of the cheese slab from adhesion with the adjacent supporting slab or from insertion of a separating tool. The force applied by the vacuum plates is safely distributed over the area of the vacuum plates.

The articulating connector may be at least one hinge allowing the outer edge of the vacuum plate to pivot upward about an inner edge near the other vacuum plate.

It is thus another object of at least one embodiment of the invention to provide a simple mechanism that may produce a peeling action to separate slabs.

The hoist may include an actuator operating between the two vacuum plates to provide an actuation force moving one vacuum plate with respect to the other vacuum plate.

It is thus another object of at least one embodiment of the invention to provide a hoist that breaks the suction between adjacent slabs of cheese prior to hoisting of the cheese slab.

The articulating connector may allow the two vacuum plates to move symmetrically with respect to each other to substantially simultaneously peel opposite edges of the supported cheese slab away from the surface on which it rests.

Thus it is another object of at least one embodiment of the invention to provide a hoist that releases the slab evenly and that provides faster and more robust separation of the slabs by peeling two edges at once.

The hoist may include a center plate and the two vacuum plates may flank the center plate and be attached to the center plates so that the center plate may remain substantially horizontal during independent movement of the vacuum plates.

It is thus another object of at least one embodiment of the invention to distribute the bending of the cheese to reduce damage to the cheese. The multiple hinge lines to reduce the bending of the slab at any one point.

The actuator may be supported by the center plate and connected to the outer edges of the two vacuum plates to simultaneously pull the outer edges of the two vacuum plates upward. The actuator may be a pneumatic cylinder having an actuator shaft extending vertically therefrom and connected via pivots to downwardly extending arms attached to pivots on each of the vacuum plates at points removed from the hinges.

It is thus another object of at least one embodiment of the invention to provide a simple mechanism for providing the necessary movement of the vacuum plates and suitable for use in the food industry.

The hoist may include a stop limiting the independent movement of the vacuum plates to a predetermined amount.

It is thus another object of at least one embodiment of the invention to ensure that the cheese is not overstressed such as may cause damage.

The lower surface of the vacuum plates are substantially planar plates with regularly spaced holes communicating via manifold to a vacuum line. The plate may include a peripheral ridge sealing the cheese to the plate.

It is thus another object of at least one embodiment of the invention to provide an improved method of separating cheese slabs that still provides a broad area support to the cheese such as may be provided by a vacuum plate.

These particular objects and advantages may apply to only some embodiments falling within the claims and thus do not define the scope of the invention.

### BRIEF DESCRIPTION OF THE DRAWINGS

FIG. 1 is a simplified perspective view of a prior art vacuum hoist used for separating cheese slabs;

FIG. 2 is a perspective view of the articulated vacuum hoist of the present invention with vacuum lines, vacuum valve, and actuator structure removed for clarity and in partial cutaway;

FIG. 3 is a side elevational view of the vacuum hoist of FIG. 2 showing a first planar configuration of the vacuum plates when the vacuum hoist is initially placed on a cheese slab;

FIG. 4 is a figure similar to that of FIG. 3 showing a second convex configuration of the vacuum plates used to peel the cheese slabs apart prior to hoisting of an upper slab;

FIG. 5 is a cross-sectional view through one vacuum plate of FIG. 2 showing the airflow, and a block diagram showing the control structure for controlling the vacuum hoist of the present invention; and

FIG. 6 is a figure similar to that of FIG. 2 showing an alternative embodiment of the invention in which a diagonal hinge axis is used to allow upward flexure of a corner of the vacuum plate.

### DETAILED DESCRIPTION OF THE PREFERRED EMBODIMENT

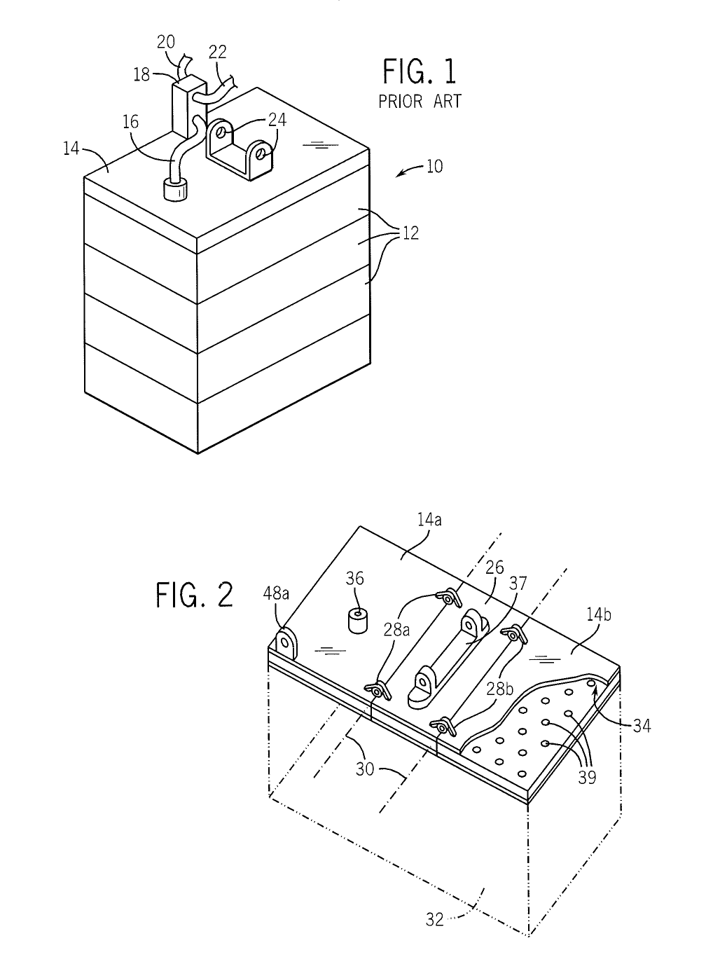

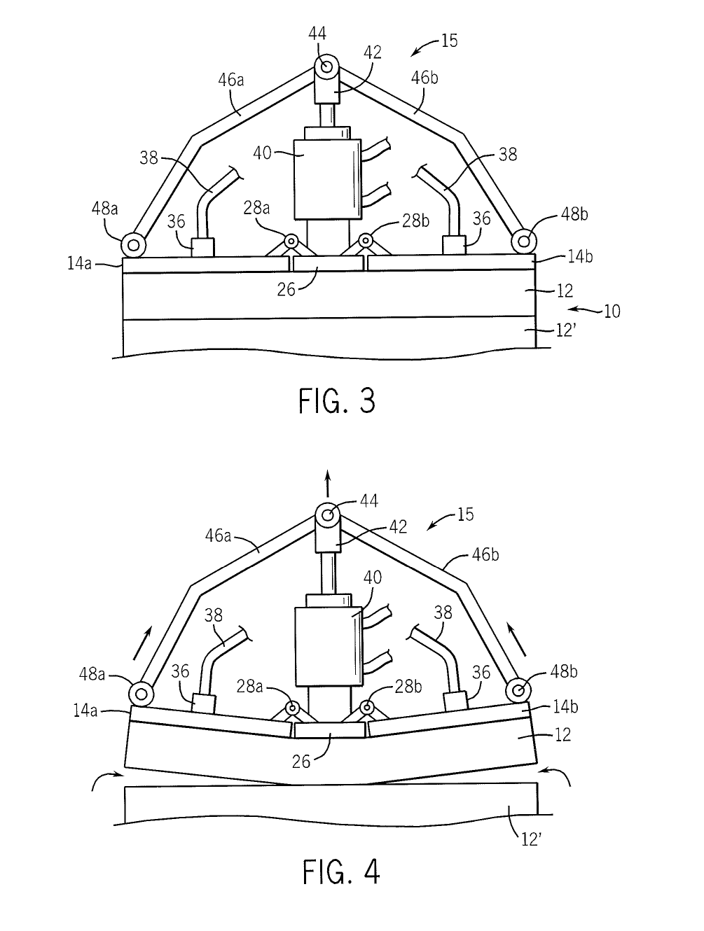

Referring now to FIGS. 2 and 3, a vacuum plate hoist 15 of the present invention provides a left and right generally rectangular vacuum plate 14a and 14b separated by a hinge plate 26. Hinge plate 26 has a left edge attached to the right edge of vacuum plate 14a by means of hinges 28 and has a right edge attached to a left edge of vacuum plate 14b by means of hinges 28b.

The vacuum plates 14a and 14b may thus swing upward about hinge axes 30 of the hinges 28a and 28b so that the vacuum plates 14a and 14b are angled with respect to hinge plate 26 to present a convex lower surface (shown generally in FIG. 4) or may swing downward to present a planar lower surface (shown generally in FIG. 3) where each of the vacuum plates 14a and 14b and hinge plate 26 are coplanar together to define an area 32 substantially matching an upper surface of a slab 12.

The hinges 28a and 28b joining vacuum plates 14a and 14b to hinge plate 26 are attached to the upper surfaces of the vacuum plates 14a, 14b, and hinge plate 26 so that the edges of the vacuum plates 14a and 14b abutting against edges of the hinge plate 26 naturally stop the vacuum plates 14a and 14b from angling downward past a planar configuration.

A hoist mount 37 may be attached to the center of the upper surface of the hinge plate 26 to provide a point of attachment between the present invention and a hoist.

Also attached to the upper surface of the hinge plate 26 is a pneumatic actuator 40 having an actuator shaft 42 that may move under the influence of air pressure in a vertical direction. The actuator 40 may have controllable stroke, for example, through the use of a threaded stop of the like, to allow adjustment of the maximum upward extent of the actuator shaft 42. The actuator shaft 42 is connected by means of a pivot joint 44 to two downwardly extending arms 46a and 46b which attach, respectively, to pivot points 48a and 48b on outer edges of vacuum plates 14a and 14b spaced from the hinges 28a and 28b.

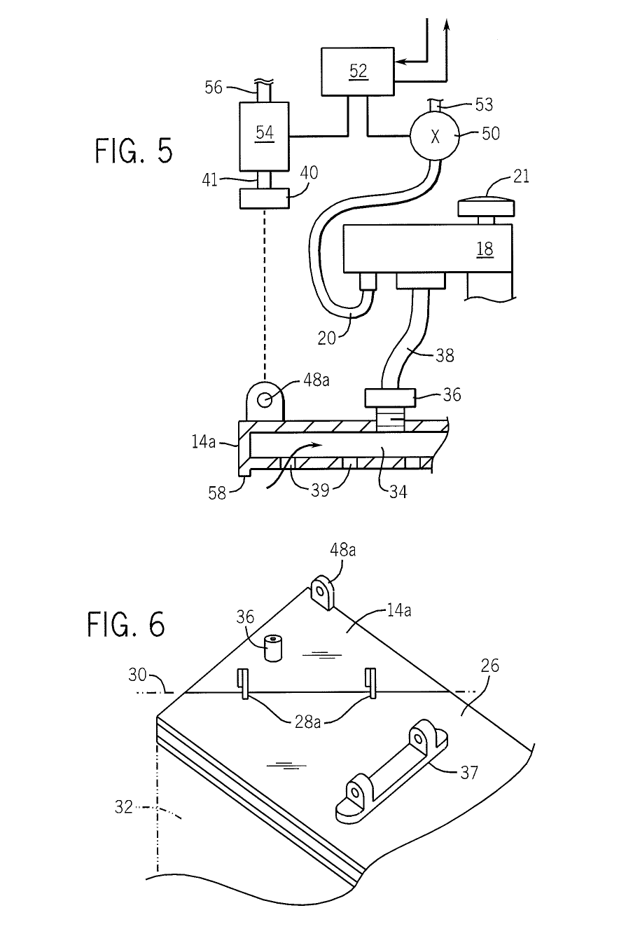

Referring to FIGS. 2 and 5, each of vacuum plates 14a and 14b provides a manifold formed by an internal hollow chamber 34 joining an upwardly extending vacuum fitting 36 with a series of regularly spaced holes 39 through the lower surface of the vacuum plates 14a and 14b. The lower surface of the vacuum plates 14a and 14b may further include a downwardly extending peripheral ridge 58 sized to engage the soft surface of the cheese slab 12. Air may pass through the holes 39 into hollow chamber 34 and out vacuum fitting 36 so as to establish a low pressure between the lower surface of the vacuum plates 14a and 14b and the upper surface of a cheese slab 12 retained by a pressing of the upper surface of the slab 12 against the lower surface of the vacuum plates 14a and 14b and the downwardly extending peripheral ridge 58.

The hinge plate 26 may be a solid plate without lower holes 39, however, it will be understood to one of ordinary skill in the art that the manifold construction of vacuum plates 14a and 14b may also be applied to hinge plate 26 so as to provide additional lift if necessary.

Referring now to FIG. 3, in use, the vacuum plate hoist 15 may be placed on a topmost slab 12 of a stack of slabs, resting on a lower slab 12′, with the area 32 of the vacuum plate hoist 15 aligned with the upper area of the slab 12. Initially, the actuator shaft 42 is in its lowermost position allowing the vacuum plates 14a and 14b to start in planar configuration with coplanar vacuum plates 14a and 14b and hinge plate 26.

A low pressure is then established between the lower surface of the vacuum plates 14a and 14b and the upper surface of the slab 12 by means of vacuum lines 38 communicating with vacuum fittings 36 as described above. Referring also to FIG. 5, the vacuum line 38 may be connected to a venturi-type vacuum pump 18 which receives through an air line 20 a source of compressed air controlled by an electrical valve 50 of a type well known in the art. The vacuum pump 18 may include a vacuum gauge 21. An electrical signal to the electrical valve 50 may come from an operator or an automatic controller 52 as will be described below.

Referring now to FIG. 4, once the vacuum plate hoist 15 is in place on top of the stack 10 of slabs 12, and a vacuum is drawn through vacuum lines 38, the actuator 40 is activated to move the actuator shaft 42 upward. Referring also to FIG. 5, the actuator 40 may be connected to an electrical valve 54 of a type well known in the art and placed in series between a primary pneumatic line 56 fed by an external pump (not shown) and an air line 41 connected to the actuator 40. An electrical signal to the electrical valve 54 may come from an operator or an automatic controller 52 as will be described below.

As the actuator shaft 42 rises, arms 46a and 46b are simultaneously raised, in turn, lifting the outer edges of vacuum plates 14a and 14b and, as a result of the low pressure drawn through vacuum lines 38, lifting the slab 12 so as to peel the outer edges of the slab 12 back away from the outer edges of the supporting slab 12′.

Although the inventor does not wish to be bound by a particular theory, this peeling action is believed to both break the suction between the slabs 12 and 12′ and, by concentrating any adhesive forces between the slabs at a boundary that sweeps back from the edge of the slabs 12 and 12′ toward its center, to reduce adhesive spalling that can break off chunks of cheese from the interface surface.

The actuator 40 provides an internal or external stop (not shown) limiting the height of the actuator shaft 42 and thus limiting the amount of upward flex of the vacuum plates 14a and 14b about the hinge plate 26. This flexure amount is set so as to provide the necessary peeling action, but not to unduly stress the cheese by bending such as might cause it to fracture. A reduction of bending fracture is also obtained through the use of two sets of hinges 28a and 28b which distribute the bending of the cheese slab 12 over two hinge axes 30 (shown in FIG. 2).

Once the peeling action is complete, a hoist may be activated lifting the vacuum plate hoist 15 upward by the hoist tabs 24 (shown in FIG. 2) to move the cheese slab 12 away from the slab 12′ as required for further processing.

Referring to FIG. 5, the steps described above may be controlled manually or by an electrical controller 52 which provides necessary sequencing to the operations if automatic operation is desired. The controller 52 may also communicate with valves 50 and 54 to first establish the vacuum between the vacuum plates 14 and the cheese slab 12 (not shown in FIG. 5) and then to operate the actuator 40 after a sufficient time has passed for the low pressure to be established. Thus, for example, a single operator button may cause both an establishment of the vacuum, and a peeling away of the cheese slab from the cheese slab 12′.

Optionally, the controller 52 may moderate a hoist signal so as to automatically begin these operations prior to any lifting by the hoist after positioning of the vacuum plate hoist 15 is established. In this case, the sequence of operations is triggered by the hoist signal itself. A manual release signal may release the slab 12 via valve 50 after moving of the slab 12 is complete.

Referring now to FIG. 6, in an alternative embodiment of the present invention, a triangular vacuum plate 14a (being a corner of the generally rectangular lifting surface) may be separated from a trapezoidal hinge plate 26 along a diagonal hinge axes 30 to swing upward therefrom. In this embodiment, only a single vacuum plates 14a may be required and the hinge plate 26 may have a vacuum fitting 36 (not shown) so that the full area of the combined plates may be used for lifting. This configuration allows the slab 12 to be separated from the other slabs 12′ starting at a corner of the slab 12 in a natural peeling action. In other respects this embodiment may work as described above with respect to FIGS. 3-5.

It will be understood from the above description to those of ordinary skill in the art that variations in the invention may include additional vacuum plates 14 in various sizes to accommodate different sizes of cheese slabs and joined with a variety of mechanisms. Further it will be understood that, although the preferred embodiment uses an actuator 40, that the articulation of the vacuum plates 14a and 14b may be provided by other means including, for example, the hoisting action itself and that other types of actuators may be used.

It is specifically intended that the present invention not be limited to the embodiments and illustrations contained herein, but include modified forms of those embodiments including portions of the embodiments and combinations of elements of different embodiments as come within the scope of the following claims.

I claim:

1. A cheese hoist comprising:
at least two vacuum plates having lower surfaces sized to retain a vacuum between the lower surfaces and an upper surface of a cheese slab over an area sufficient to support the cheese slab, at least one vacuum plate positionable adjacent to an edge of the cheese slab; and
a connector between the vacuum plates to allow the one vacuum plate to move independently with respect to the other vacuum plate to peel a supported cheese slab away from a surface on which the supported cheese slab rests.

2. The cheese hoist of claim 1 wherein the connector is a least one hinge allowing an outer edge of the one vacuum plate to pivot upward about an inner edge near the other vacuum plate.

3. The cheese hoist of claim 1 further including an actuator operating between the two vacuum plates to provide an actuation force moving one vacuum plate with respect to the other vacuum plate.

4. The cheese hoist of claim 1 wherein the connector allows the two vacuum plates to move symmetrically to substantially simultaneously peel opposite edges of the supported cheese slab away from the surface on which it rests.

5. The cheese hoist of claim 4 further including a center plate and wherein the two vacuum plates flank the center plate and are attached to the center plate so that the center plate may remain substantially horizontal during independent movement of each of the vacuum plates.

6. The cheese hoist of claim 4 wherein the two vacuum plates flank and move symmetrically about a center plate that remains substantially horizontal during movement of the two vacuum plates.

7. The cheese hoist of claim 5 further including hinges connecting inner edges of the vacuum plates to the center section.

8. The cheese hoist of claim 7 further including an actuator supported by the center plate and connecting to outer edges of the two vacuum plates to simultaneously pull the outer edges of the two vacuum plates upward.

9. The cheese hoist of claim 8 wherein the actuator is a pneumatic cylinder having an actuator shaft extending vertically therefrom and connected via pivots to downwardly extending arms attached to pivots on each of the vacuum plates at points removed from the hinges.

10. The cheese hoist of claim 1 including a stop limiting an independent movement of the vacuum plates to a predetermined amount.

11. The cheese hoist of claim 1 wherein the lower surfaces of the vacuum plates are substantially planar plates with regularly spaced holes communicating via a manifold to a vacuum line.

12. The cheese hoist of claim 1 wherein the plate includes a peripheral ridge sealing the cheese to the plate.

13. The cheese hoist of claim 1 wherein the two vacuum plates together form a rectangular surface and one of the vacuum plates forms only a corner of the rectangular surface.

14. A method of separating slabs of cheese comprising the steps of:
(a) attaching at least two interconnected vacuum plates on a substantially planar upper surface of a cheese slab by drawing a vacuum between lower surfaces of the vacuum plates and the upper surface of the cheese slab sufficient to support the cheese slab;
(b) independently move at least one of the vacuum plates with respect to the other vacuum plate to peel a supported cheese slab away from a lower cheese slab on which the supported cheese slab rests; and
(c) raise the vacuum plates to fully separate the supported cheese slab from the lower cheese slab.
